(19) United States
(12) Patent Application Publication
(10) Pub. No.: US 2020/0075273 A1
(43) Pub. Date: Mar. 5, 2020

(54) SLIDING MECHANISM AND KEYBOARD APPARATUS

(71) Applicant: YAMAHA CORPORATION, Hamamatsu-shi (JP)

(72) Inventor: Kento OGAWA, Funabashi-shi (JP)

(21) Appl. No.: 16/676,948

(22) Filed: Nov. 7, 2019

Related U.S. Application Data
(63) Continuation of application No. PCT/JP2017/019945, filed on May 29, 2017.

(51) Int. Cl. H01H 21/24; G10H 1/34

(52) U.S. Cl. CPC H01H 21/24; G10H 1/346; H01H 2231/018; H01H 2221/082; H01H 2209/016

(57) ABSTRACT

A sliding mechanism includes a first member, a second member harder than the first member and a plurality of particulate third members sandwiched between the first member and the second member and disposed to be slidable on the second member. The sliding mechanism is applicable to a keyboard apparatus. In particular, the sliding mechanism is applicable to a portion that slides according to a depression of a key in the keyboard apparatus.

### CROSS-REFERENCE TO RELATED APPLICATIONS

This application is a U.S. continuation application filed under 35 U.S.C. § 111(a), of International Application No. PCT/JP2017/019945, filed on May 29, 2017, the disclosures of which are incorporated by reference.

### FIELD

The present invention relates to a sliding mechanism.

### BACKGROUND

In order to apply a load when a key is depressed in an electronic keyboard apparatus, a structure is employed in which a mass body corresponding to a hammer of an acoustic piano is revolved according to the depression of the key. Such a structure may have a sliding mechanism provided in a part where a key and a mass body are connected to each other. For example, according to the technology disclosed in PTL 1 (Japanese Patent No. 3591579), a structure is disclosed in which a piece of rubber pasted to a key and the head of a screw attached to a mass body slide on each other according to the depression of the key.

### SUMMARY

According to an embodiment of the present invention, there is provided a sliding mechanism including: a first member; a second member harder than the first member; and a plurality of particulate third members sandwiched between the first member and the second member and disposed to be slidable on the second member.

### BRIEF DESCRIPTION OF DRAWINGS

FIG. 1 is a diagram explaining a schematic explanatory diagram of a keyboard apparatus according to a first embodiment of the present invention.

FIG. 2 is an explanatory diagram of a sliding mechanism according to the first embodiment of the present invention.

FIG. 3 is an explanatory diagram of a sliding mechanism according to a second embodiment of the present invention.

FIG. 4 is an explanatory diagram of a sliding mechanism according to a third embodiment of the present invention.

FIG. 5 is an explanatory diagram of a sliding mechanism according to a fourth embodiment of the present invention.

FIG. 6 is an explanatory diagram of a sliding mechanism according to a fifth embodiment of the present invention.

### DESCRIPTION OF EMBODIMENTS

In the following, a keyboard apparatus including a sliding mechanism according to an embodiment of the present invention is described in detail with reference to the drawings. The embodiments to be hereinafter prescribed are examples of embodiments of the present invention, and the present invention is not limited to these embodiments. It should be noted that in the drawings that are referred to in the present embodiment, identical parts or parts having the same functions are given identical signs or similar signs (signs each formed simply by adding A, B, or the like to the end of a number) and a repeated description thereof may be omitted. Further, the dimensional ratios of the drawings (such as the ratios between components and the ratios of length, width, and height directions) may be different from actual ratios for convenience of explanation, and some of the components may be omitted from the drawings.

### First Embodiment

### [Configuration of Keyboard Apparatus 1]

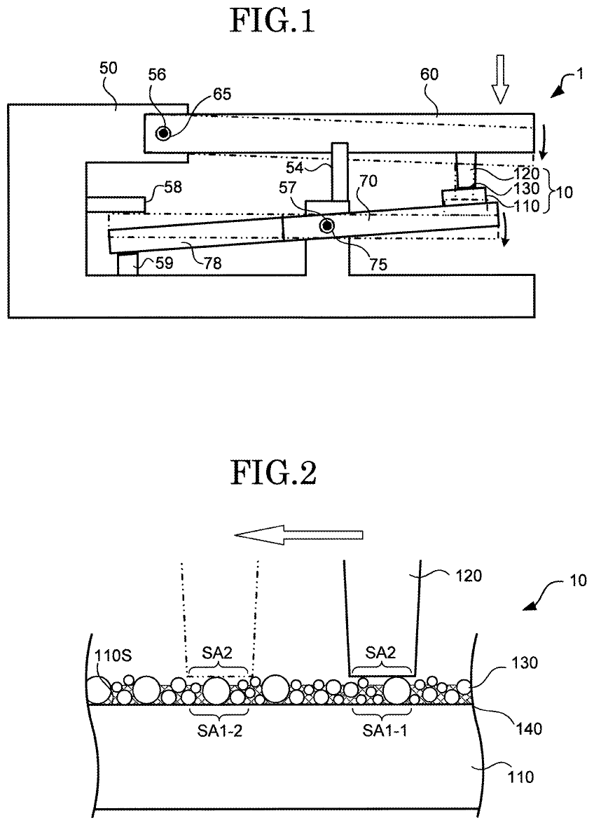

FIG. 1 is a diagram explaining a schematic explanatory diagram of a keyboard apparatus according a first embodiment of the present invention. A keyboard apparatus 1 according to the first embodiment is an example in which an example of a sliding mechanism according to the present invention is applied to an electronic piano. It should be noted that although the keyboard apparatus 1 includes various components other than those shown in FIG. 1, e.g. a sensor that detects the position of a key and a sound source device that generates a sound waveform in accordance with an output signal from the sensor, this example omits to illustrate such components.

According to the technology disclosed in PTL 1, in a case where a soft member such as a piece of rubber and a hard member such as the head of a screw slide on each other, a predetermined force of friction is generated. Since, in such a configuration, a coefficient of friction affects a load that is applied when the key is depressed, a design needs to be made so that a predetermined coefficient of friction is attained. However, for the attainment of the predetermined coefficient of friction, a combination of materials, a surface condition, or the like must be adjusted, and this adjustment requires a lot of labor.

An embodiment of the present invention makes it possible to easily set a sliding mechanism to a predetermined coefficient of friction.

The keyboard apparatus 1 includes a frame 50, a key 60, and a mass body 70. The key 60 is revolvably supported on the frame 50. In this example, the key 60 is supported on the frame 50 by a spindle 56 provided in the frame 50 and a bearing 65 provided in the key 60. That is, the spindle 56 serves an axis on which the key 60 revolves. Alternatively, a spindle may be provided in the key 60, and a bearing may be provided in the frame 50.

The key 60 has its direction of revolution regulated by a guide 54 provided in the frame 50. In this example, the guide 54 is in contact with both sides of the key 60 along an array direction (scale direction) of keys 60. This regulates the direction of revolution of the key 60 so that the key 60 revolves within a plane to which the scale direction is normal. It should be noted that the direction of revolution may be regulated by the spindle 56 and the bearing 65. Accordingly, the guide 54 is optional.

A hard member 120 (second member) is connected to the key 60. In this example, the hard member 120 is disposed to project downward from the key 60.

The mass body 70 is revolvably supported on the frame 50. In this example, the mass body 70 is supported on the frame 50 by a spindle 57 provided in the frame 50 and a bearing 75 provided in the mass body 70. Alternatively, a spindle may be provided in the mass body 70, and a bearing may be provided in the frame 50.

A soft member 110 (first member) is connected to the mass body 70. In this example, the soft member 110 is disposed at one end of the mass body 70. The soft member 110 and the hard member 120 are disposed so that particulate members 130 (third members) are sandwiched between the soft member 110 and the hard member 120. In this example, the particulate members 130 are disposed on top of the soft member 110 and are in slidable contact with the hard member 120. The soft member 110, the hard member 120, and the particulate members 130 form a sliding mechanism 10. A detailed structure of the sliding mechanism 10 will be described later.

The mass body 70 includes a weight 78 as a part thereof. The weight 78 is disposed on the side opposite the end at which the soft member 110 is disposed behind the bearing 75. The presence of the weight 78 causes the mass body 70 to have its center of gravity located closer to the weight 78 than the bearing 75.

When the key 60 is depressed (key depression), the hard member 120 slides on the particulate members 130 and causes the soft member 110 to move downward. As a result, the weight 78 moves upward and the mass body 70 revolves until the mass body 70 makes contact with a stopper 58, so that the key 60 is brought into a state of having been depressed to an end position. When the force which depresses the key 60 is released (key release), the weight 78 moves downward and the mass body 70 revolves until the mass body 70 makes contact with a stopper 59, so that the soft member 110 moves upward. As a result, the hard member 120 slides on the particulate members 130 and moves upward, so that the key 60 returns to a rest position. Alternatively, the hard member 120 may be prevented from moving away from the particulate members 130 while the key 60 is returning from the end position to the rest position. A publicly-known structure may be used, for example, by utilizing a key's own weight. Further, the key 60 may have its range of revolution regulated so that the key 60 does not move a higher position than the rest position. Thus, the mass body 70 is a member that revolves when the key 60 is depressed and, in terms of applying a load to a key depression, is a member that is equivalent to a hammer of an acoustic piano.

### [Configuration of Sliding Mechanism 10]

The following describes the sliding mechanism 10 with reference to FIG. 2.

FIG. 2 is an explanatory diagram of a sliding mechanism according to the first embodiment of the present invention. As mentioned above, the sliding mechanism 10 includes the soft member 110, the hard member 120, and the plurality of particulate members 130. The soft member 110 is an elastic body made of rubber or the like. The hard member 120 is made of hard resin or the like integrally molded with the key 60. It should be noted that the hard member 120 needs only be harder than the soft member 110. Therefore, there can be various combinations of a material of the soft member 110 and a material of the hard member 120.

The particulate members 130 are substantially spherical members. In this example, the particulate members 130 is made of a material that is harder than the soft member 110 and softer than the hard member 120. It should be noted that the particulate member 130 may be softer than the soft member 110 and harder than the hard member 120. Further, the particulate members 130 do not need to be substantially spherical but needs only be particulate. Therefore, the particulate members 130 may have shapes, such ellipsoids, constituted by closed surfaces or may have shapes partly or wholly formed by planes. Further, as shown in FIG. 2, the plurality of particulate members 130 may be partly different in particle diameter or may be wholly identical in particle diameter. The term “particle diameter” here (which corresponds to the particle diameter R shown in FIG. 4) refers to the diameter of a sphere or, in the case of a non-spherical structure, refers to the longest one of the distances between two points on the surface.

In this example, the plurality of particulate members 130 are dispersed over a surface 110S of the soft member 110 and fixed by an adhesive 140. Accordingly, the particulate members 130 do not move with respect to the surface 110S, nor do they rotate at the same position. It should be noted that the particulate members 130 may be fixed to the surface 110S of the soft member 110 by a different method (e.g. deposition, adhesion, or the like).

The position (indicated by a solid line) of the hard member 120 shown in FIG. 2 assumes that the key 60 is in the rest position. At this point of time, the particulate members 130 are sandwiched between a first region SA1 (SA1-1, SA1-2) of the soft member 110 and a second region SA2 of the hard member 120. The first region SA1 is a region of the soft member 110 that faces the hard member 120. The second region SA2 is a region of the hard member 120 that faces the soft member 110.

When the key 60 is depressed, the hard member 120 moves in the direction of an arrow, and when the key 60 reaches the end position, the hard member 120 moves to a position indicated by a chain double-dashed line. In this way, with reference to the soft member 110, the hard member 120 moves along the surface 110S of the soft member 110 while being in slide contact with the particulate members 130. In this example, there is no change in position of the second region SA2 on the hard member 120. Meanwhile, there is a change in position of the first region SA1 on the soft member 110 from the region SA1-1 to the region SA1-2. That is, it can also be said that the soft member 110 is an intermittent sliding side and the hard member 120 is a continuous sliding side. Although, in actuality, the soft member 110 slides via the particulate members 130, the following description assumes that as a whole of the sliding mechanism 10, the soft member 110 is an intermittent sliding side.

The hard member 120 transmits force from the key 60 to the soft member 110 while sliding in contact with the particulate member 130 instead of sliding in contact with the soft member 110. Forces of friction generated by contact between the hard member 120 and the particulate members 130 can vary according to the shape (outer shape, size, or the like), distribution (mixture ratio of multiple shapes, density of dispersion, or the like), and material of particulate members 130 that are fixed to the soft member 110. Accordingly, when particulate members 130 with variations in these parameters are disposed on top of the soft member 110, the sliding mechanism 10 can be adjusted to various coefficients of friction. This makes it possible to easily attain a desired coefficient of friction of the sliding mechanism 10. It should be noted that in the following description, the term “coefficient of friction”, put simply, refers to a coefficient of friction of the sliding mechanism 10 and does not refer to a coefficient of friction between the hard member 120 and the particulate members 130.

Further, since sliding takes place without contact between the soft member 110 and the hard contact member 120, the wearing away of the soft member 110 can be reduced. At this point of time, in reaction to force from the hard member 120, the soft member 110 can elastically deform as a whole via the particulate members 130. Accordingly, a restoring force attributed to the elastic deformation of the soft member 110 (i.e. a vertical force acting substantially on the surface 110S) can be transmitted as a repelling force to the hard member 120. A sliding mechanism including an elastically deformable member such as the soft member 110 is often too high in friction and has had difficulty in attaining both softness and slidability. Meanwhile, the sliding mechanism 10 makes it possible to set various degrees of friction while keeping the softness of the soft member 110 entailed by the elastic deformation.

### Second Embodiment

Although the particulate members 130 are fixed on top of the soft member 110 in the first embodiment, the particulate members 130 do not need to be fixed on top of the soft member 110. Second to fourth embodiments describe examples in which the particulate members 130 are not fixed on top of the soft member 110. First, the second embodiment describes an example in which the particulate members 130 are held between the soft member 110 and the hard member 120 by utilizing the properties of a liquid member.

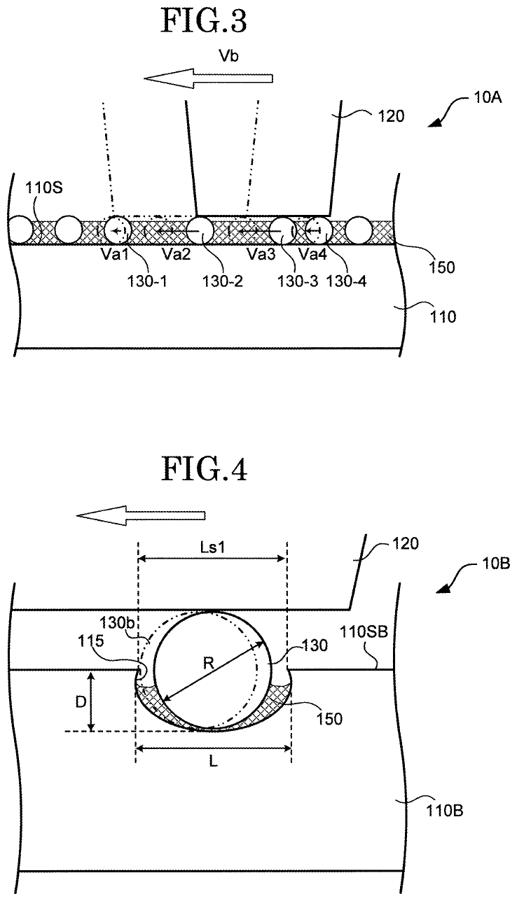

FIG. 3 is an explanatory diagram of a sliding mechanism according to the second embodiment of the present invention. A sliding mechanism 10A includes particulate members 130 (130-1, 130-2, . . . ) held between the soft member 110 and the hard member 120 by a liquid member 150. The liquid member 150 is present at least on top of the soft member 110 so as to make contact with the plurality of particulate members 130. Therefore, even while being held on top of the soft member 110, the particulate members 130 can rotate (change its posture) and can move along the surface 110S of the soft member 110. It should be noted that the resistance of the particulate members 130 to rotation and motion can be varied by varying the properties (e.g. viscosity, consistency, surface tension, and the like) of the liquid member 150. It is preferable that the liquid member 150 be a low-volatile member so as to be held between the soft member 110 and the hard member 120 for as long as possible and so that its properties vary less. Although the liquid member 150 is disposed only in a part of the space between the soft member 110 and the hard member 120 in FIG. 3, the liquid member 150 may be disposed to completely fill the space.

As shown in FIG. 3, when the hard member 120 moves, the particulate members 130 move while rotating and sliding between the soft member 110 and the hard member 120. Amounts of the movement vary depending on the positional relationship between the hard member 120 and the particulate members 130. In this example, the particulate members 130-2 and 130-3 move more than the particulate members 130-1 and 130-4, as the particulate members 130-2 and 130-3 are in contact with the hard member 120 in motion over a prolonged period of time. Note here that the velocity Vb (first relative velocity) of the hard member 120 with respect to the soft member 110 is higher than the velocities Va1, Va2, Va3, and Va4 (second relative velocities) of the particulate members 130-1, 130-2, 130-3, and 130-4 with respect to soft member 110. Note here that a stronger force of friction may be applied to the hard member 120 by making ½ of Vb higher than Va1, Va2, Va3, and Va4. This may be achieved, for example, by adjusting the properties (e.g. viscosity) of the liquid member 150 to make it harder for the particulate members 130 to move along the surface 110S.

In this example, while the soft member 110 and the hard member 120 do not make contact with each other, the particulate members 130 move over the soft member 110. However, as compared with a case where the hard member 120 slides in contact with the soft member 110, the areas of contact and amounts of movement of the particulate members 130 with respect to the soft member 110 are small, so that the wearing away of the soft member 110 can be reduced. Further, as mentioned above, the sliding mechanism 10A makes it possible to set various degrees of friction while keeping the softness of the soft member 110 entailed by elastic deformation.

### Third Embodiment

The third embodiment describes an example in which the particulate members 130 have their ranges of movement partly restricted.

FIG. 4 is an explanatory diagram of a sliding mechanism according to the third embodiment of the present invention. For ease of explanation, FIG. 4 shows an enlarged view of one particulate member 130 and the area therearound. A sliding mechanism 10B includes a soft member 110B having a plurality of recesses 115 disposed in a surface 110SB. A portion of the particulate member 130 is disposed to be fitted in a recess 115. Inside the recess 115, the liquid member 150 is disposed, as is the case with the second embodiment. It should be noted that the liquid member 150 may be disposed to spread out of the recess 115 and does not need to be present between the soft member 110B and the hard member 120.

The particulate member 130 is subjected to force by the hard member 120 so as to be prevented from moving in a direction away from the soft member 110B. Therefore, even when the hard member 120 slides on the particulate member 130, the particulate member 130 has its range of movement restricted within the recess 115 so that the particulate member 130 does not move out of the recess 115. It should be noted that the range of movement of the particulate member 130 does not necessarily completely restricted within the recess 115. That is, the particulate member 130 may move out of the recess 115, and as a result of that, another particulate member 130 may enter this recess 115.

The shape of the particulate member 130 and the shape of the recess 115 have the following relationship. First, the depth D of the recess 115 (i.e. the distance from a position corresponding to the surface 110SB to the bottom of the recess 115) is smaller than the particle diameter R of the particulate member 130. As a result, when one particulate member 130 enters the recess 115, a portion of the particulate member 130 is exposed from the surface 110SB and can make contact with the hard member 120.

Further, the size L of the recess 115 is equal to or larger than the particle diameter R of the particulate member 130 and is less than a double of the particle diameter R. In this example, the size L of the recess 115 is defined in the following way. Two points on an inner surface of the recess 115 placed along a direction of movement of the hard member 120 with respect to the soft member 110B are defined. The longest one of these distances between two points is the size L of the recess 115. It should be noted that the recess 115 may be in the form of a groove extending in a direction parallel to the surface 110SB and different from the direction of movement of the hard member 120.

According to such a relationship between the size L and the particle diameter R, one particulate member 130 is disposed in the recess 115 in the direction of movement of the hard member 120. It should be noted that of the distances between two points, the distance between two points on the surface 110SB (i.e. the opening edge of the recess 115) may be defined as a size Ls1, and under the foregoing conditions, the size L may be replaced by the size Ls1. Depending on the shape, the size L may be defined by two points located at the opening edge. In this case, the size L and the size Ls1 are equal to each other.

Not all particulate members 130 and recesses 115 satisfy these conditions in relation to each other. That is, there only need to be combinations of any of the plurality of particulate members 130 and any of the plurality of recesses 115 that satisfy the foregoing conditions in relation to each other. It should be noted that the foregoing conditions are just an example in which a predetermined coefficient of friction is attained, and there may be a case where no combinations of a particulate member 130 and a recess 115 satisfy the conditions.

It should be noted that by adjusting the relationship between the particle diameter R of the particulate member 130 and the size L of the recess 115, coefficients of frictions can be varied between a point of time at which the hard member 120 has started to move and a point of time at which the hard member 120 has moved a predetermined amount. For example, at a point of time at which the hard member 120 has started to move, the particulate member 130 can comparatively freely move within the recess 115. That is, the situation is close to that of the second embodiment. Meanwhile, after the hard member 120 has moved a predetermined amount, the particulate member 130 falls into a state of being caught by an end of the recess 115 (i.e. the position of a particulate member 130b as indicated by a chain double-dashed line in FIG. 4). That is, the situation is close to that of the first embodiment, although the particulate member 130 is rotatable. As a result of this, a situation can be achieved in which the sliding mechanism 10B becomes larger in coefficient of friction as the hard member 120 moves.

### Fourth Embodiment

The fourth embodiment describes a case where the particulate member 130 cannot move but are enabled to rotate at the same position.

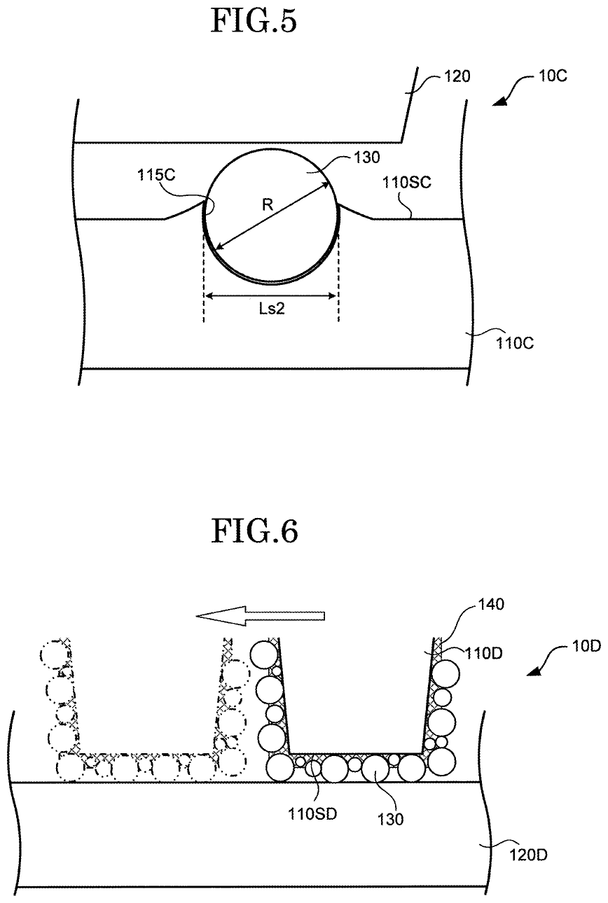

FIG. 5 is an explanatory diagram of a sliding mechanism according to the fourth embodiment of the present invention. A sliding mechanism 100 includes a soft member 110C having a recess 115C whose size Ls1 is smaller than the particle diameter R and whose size L is larger than (substantially equal to) the particle diameter R as compared with the soft member 1106 of the third embodiment. A particulate member 130 is in a state of being fitted in the recess 115C by being pushed in. Therefore, the recess 115 has its opening edge extended to a size Ls2 by the particulate member 130. This causes a surface 110SC to be elastically deformed around the particulate member 130. In this state, the particulate member 130 is able to change its posture, for example, by rotating, although it cannot move with respect to the soft member 110C in either the direction of movement of the hard member 120 or a direction perpendicular to a surface 115SC.

### Fifth Embodiment

Although each of the embodiments described above has described an example in which the hard member 120 is a continuous sliding side, the hard member 120 may be an intermittent sliding side. A fifth embodiment describes an example of a case where the continuous sliding side and the intermittent sliding side are transposed in the first embodiment.

FIG. 6 is an explanatory diagram of a sliding mechanism according to the fifth embodiment of the present invention. A sliding mechanism 110D includes a soft member 110D, a hard member 120D, and particulate members 130. In the sliding mechanism 10D, the soft member 110D is disposed in the position of the hard member 120 in the first embodiment, and the hard member 120D is disposed in the position of the soft member 110 in the first embodiment. That is, in this example, the soft member 110D is a continuous sliding side, and the hard member 120D is an intermittent sliding side. Moreover, in this example, the soft member 110D is connected to the key 60, and the hard member 120D is connected to the mass body 70.

The particulate members 130 are fixed by an adhesive 140 on a surface 110SD of the soft member 110D. Accordingly, when the key 60 is depressed, the soft member 110D moves over the hard member 120D together with the particulate members 130. Thus, while the fifth embodiment is different from the first embodiment in that the particulate members 130 are fixed to the continuous sliding side member instead of being fixed to the intermittent sliding side member, the fifth embodiment is the same as the first embodiment in that the particulate members 130 are fixed to the soft member. Further, the fifth embodiment is the same as the first embodiment in that the particulate members 130 are disposed to be slidable on the hard member. It should be noted that as mentioned above, the configuration of the fifth embodiment is applicable to the second to fourth embodiments. In this case, the particulate members 130 need only be held by using a liquid member, recesses and the like instead of the adhesive 140 of the configuration of the fifth embodiment.

### <Modifications>

Each of the embodiments described above may also be carried out according to the following modifications. Although the following modifications describe cases where the first embodiment is modified, the same applies to cases where another embodiment is modified.

(1) In the first embodiment described above, the sliding mechanism 10 is disposed between the key 60 and the mass body 70. Alternatively, the sliding mechanism 10 may be disposed between the key 60 and the frame 50. For example, the sliding mechanism 10 may be applied in the relationship between the spindle 56 and the bearing 65 shown in FIG. 1. In this case, either the soft member 110 or the hard member 120 needs only be connected to the spindle 56, and the other member needs only be connected to the bearing 65.

Further, the sliding mechanism 10 may be applied in the relationship between the key 60 and the guide 54. In this case, too, either the soft member 110 or the hard member 120 needs only be connected to the key 60, and the other member needs only be connected to the guide 54.

(2) In the first embodiment described above, the sliding mechanism 10 is disposed between the key 60 and the mass body 70. Alternatively, the sliding mechanism 10 may be disposed between the mass body 70 and the frame 50. For example, the sliding mechanism 10 may be applied in the relationship between the spindle 57 and the bearing 75 shown in FIG. 1. In this case, either the soft member 110 or the hard member 120 needs only be connected to the spindle 57, and the other member needs only be connected to the bearing 75.
(3) The first embodiment described above has shown an electronic piano as an example of a keyboard apparatus 1 to which a sliding mechanism 10 is applied. Meanwhile, the sliding mechanism 10 is also applicable to a part where two members slide on each other in an acoustic piano such as a grand piano or an upright piano. Examples of the two members include (A) a support heel and a capstan screw, (B) a hammer roller and a jack, (C) a support flange and a support (shaft component), (D) a hammer shank flange and a hammer shank (shaft component), and the like. It should be noted that the same applies to an electronic piano including an action mechanism of an acoustic piano.
(4) The first embodiment described above has shown an example of application of a sliding mechanism 10 to a keyboard apparatus 1. Meanwhile, the sliding mechanism 10 may be applied to a musical instrument other than a keyboard apparatus, provided it is a structural body having a part where two members slide on each other. Furthermore, the sliding mechanism 10 is applicable in various ways to any apparatus other than a musical instrument that has a part where two members slide on each other.

### REFERENCE SIGNS LIST

1 . . . keyboard apparatus, 10, 10A, 10B, 100, 10D . . . sliding mechanism, 50 . . . frame, 54 . . . guide, 56, 57 . . . spindle, 58, 59 . . . stopper, 60 . . . key, 65 . . . bearing, 70 . . . mass body, 75 . . . bearing, 78 . . . weight, 110, 110B, 110C, 110D . . . soft member, 115, 115C . . . recess, 120, 120D . . . hard member, 130, 130-1, 130-2, 130-3, 130-4 . . . particulate member, 140 . . . adhesive, 150 . . . liquid member

What is claimed is:

1. A sliding mechanism comprising:
a first member;
a second member harder than the first member; and
a plurality of particulate third members sandwiched between the first member and the second member and disposed to be slidable on the second member.

2. The sliding mechanism according to claim 1, further comprising a liquid member disposed on top of the first member and making contact with the plurality of third members.

3. The sliding mechanism according to claim 1, wherein, in a case where the second member moves with respect to the first member, a first relative velocity V1 of the second member with respect to the first member is greater than second relative velocities V2 of the third members with respect to the first member.

4. The sliding mechanism according to claim 1, wherein the third members are fixed to the first member.

5. The sliding mechanism according to claim 1, further comprising a recess, defined in a surface of the first member, that restricts a movement of the third members.

6. The sliding mechanism according to claim 5, wherein the recess is extended by the third members fitted therein.

7. The sliding mechanism according to claim 5, wherein a size of the recess is equal to or greater than a particle diameter of each of the third members and is less than a double of the particle diameter.

8. The sliding mechanism according to claim 1, wherein the third members are harder than the first member and softer than the second member.

9. The sliding mechanism according to claim 1, wherein, in a case where there is a change in positional relationship between the first member and the second member, a change in position of a first region of the first member that faces the second member is greater than a change in position of a second region of the second member that faces the first member.

10. The sliding mechanism according to claim 1, wherein, in a case where there is a change in positional relationship between the first member and the second member, a change in position of a second region on the second member that faces the first member is larger than a change in position of a first region on the first member that faces the second member.

11. A keyboard apparatus comprising:
a key;
a sliding mechanism according to claim 1, the sliding mechanism being connected to the key; and
a mass body, connected to the sliding mechanism, that revolves according to a depression of the key,
wherein one member of the first member and the second member is connected to the key, and
the other member of the first member and the second member is connected to the mass body.

12. A keyboard apparatus comprising:
a frame;
a key that revolves with respect to the frame; and
a sliding mechanism according to claim 1, the sliding mechanism being connected to the frame and the key,
wherein one member of the first member and the second member is connected to the key, and
the other member of the first member and the second member is connected to the frame.

13. A keyboard apparatus comprising:
a key;
a mass body that revolves according to a depression of the key; and
a sliding mechanism according to claim 1, the sliding mechanism being connected to the mass body,
wherein one member of the first member and the second member is connected to a spindle serving as an axis on which the mass body revolves, and
the other member of the first member and the second member is connected to a bearing in which the spindle is held.
